(19) United States
(12) Patent Application Publication
(10) Pub. No.: US 2012/0257929 A1
(43) Pub. Date: Oct. 11, 2012

(54) Methods for Inhibiting Hydrogen Sulfide Emissions from Waste Materials

(75) Inventors: Gary R. Hater, Cincinnati, OH (US); Gregory C. Cekander, The Woodlands, TX (US)

(73) Assignee: WASTE MANAGEMENT, INC., Houston, TX (US)

(21) Appl. No.: 13/438,784

(22) Filed: Apr. 3, 2012

Related U.S. Application Data
(60) Provisional application No. 61/472,000, filed on Apr. 5, 2011.

(51) Int. Cl. B09B 5/00; C09D 1/00

(52) U.S. Cl. 405/129.95; 106/286.3

(57) ABSTRACT

Methods of remediating construction and demolition waste by collecting sulfur containing construction and demolition waste materials, adding a sulfur stabilizing agent to the construction and waste materials, admixing the sulfur containing construction and demolition waste materials and the sulfur stabilizing agent to form a sulfur stabilized construction and demolition waste material.

This application claims the benefit of the filing date of provisional application Ser. No. 61/472,000 filed on Apr. 5, 2011, the specification of which is incorporated herein by reference in its entirety.

### BACKGROUND OF THE INVENTION

(1) Field of the Invention

This invention concerns chemical and physical methods and structures for the reactive inhibition of hydrogen sulfide in sulfur containing construction debris and demolition materials.

(2) Description of the Related Art

Recently it was discovered that drywall manufactured in China has high sulfate content. The high sulfate content makes it more likely that hydrogen sulfide gas could leach from the drywall in amounts sufficient to damage and/or corrode household appliances and fixtures. As a result, drywall manufactured in China has been or is being removed from homes and other buildings. In addition, during new construction and during home and business demolition/renovation, drywall and other construction debris—whether manufactured in China or elsewhere—that contain sulfates are directed to landfills.

One way in which construction and demolition debris are used at landfills is as a daily cover material. The materials are a good daily cover material because they are generally comprised of biologically inert non-compostable materials and therefore, do not generate organic decomposition odors. In general construction and demolition (C&D) fines are collected and used as daily fill by placing the C & D fines over compostable materials placed in a landfill at the end of each day to inhibit the emission of odor causing organic compounds into the air.

The presence of drywall (gypsum/CaSO₄) and other sulfur containing compounds in the C&D fines can result in hydrogen sulfide gas being generated from the C&D fines when they are combined with trash, buried, or when excessive rain or snow leaches the sulfate out of the fines and into the trash where it can ferment to form hydrogen sulfide gas. Hydrogen sulfide gas has a very strong odor when even tiny amounts are present in the air. And large concentrations of hydrogen sulfide gas can pose a health danger. As a result, there is a need to inhibit and/or prevent the generation of hydrogen sulfide gas from C&D fines so that they can be disposed of in general purpose landfills and/or used as daily cover, for a road base material at landfills or used for other purposes.

### SUMMARY OF THE INVENTION

Aspects of this invention involve methods that include adding one or more sulfur stabilizing agents, such as metal oxides and metal hydroxides (e.g., iron and calcium), to dry constructions and demolition materials so the materials can be landfilled or so the materials can be used instead of or in addition to soil as a landfill daily cover, as a road base material or for many other useful purposes.

In one aspect, this invention includes a method whereby one or more sulfate stabilizing agents are applied to C&D fines and admixed. The combined sulfur stabilized C&D fines can then be used as landfill daily cover or as a landfill road base material. When the cover or when the haul road is no longer needed, new municipal solid waste or construction and demolition waste can be placed on top of the combined material without fear of H₂S gas formation.

Another aspect of this invention is a method of remediating construction and demolition waste comprising the steps of: collecting sulfur containing construction and demolition waste materials; reducing the particle size of the sulfur containing construction and demolition waste materials to an average particle size of from about 0.1 mm to about 2 inches; adding hydrated lime to the size reduced construction and waste materials; admixing the size reduced sulfur containing construction and demolition waste materials and the hydrated lime in an amount ranging from about 15 lbs. per ton to about 50 lbs. per ton to form a sulfur stabilized construction and demolition waste material; and using the sulfur stabilized construction and demolition waste material in an landfill application.

This invention further includes municipal solid waste landfills comprising: a plurality of municipal solid waste layers; and a layer of daily cover material separating at least two of the plurality of municipal solid waste layers wherein the daily cover material is an admixture of at least one sulfur stabilizing agent and sulfur containing construction and demolition fines.

### BRIEF DESCRIPTION OF THE FIGURES

FIG. 1 is a flow diagram of an experimental column system used to test the impact of different sulfur stabilizing compounds on sulfate containing C & D fines;

FIGS. 2A, 2B and 2C are plots of some of the results of the batch leaching tests of Example 2;

FIG. 3 is a plot of the amount of hydrogen sulfide gas over time in the headspace of drums tested in Example 3; and

FIG. 4 is a plot of the amount of hydrogen sulfide in gas over time in the headspace of drums tested in Example 3 excluding those drums seeded with cow manure.

### DESCRIPTION OF VARIOUS ASPECTS OF THE INVENTION

The present invention is directed to inhibiting the generation of hydrogen sulfide gas from sulfur containing C & D fines. C & D fines are a waste material that can be recycled and used for many purposes or it can be disposed of in a landfill. Many C & D materials include sulfur compounds. One large source of source of sulfur compounds in C & D fines is gypsum board or drywall that is broken up into fine pieces when the construction and demolition debris is processed for recycling or for disposal. The sulfur content of this material can range from above 0% by weight to as much 15% by weight or more. When C & D fines including sulfur compounds are exposed to anaerobic conditions e.g., after burial or when combined with water and organic matter, the material goes from being exposed to oxidizing conditions to reducing conditions which promotes the growth of bacteria that covert sulfur and sulfates (SO₄⁻²) to hydrogen sulfide gas (H₂S). Hydrogen sulfide gas is dangerous and can be deadly at high concentrations. Hydrogen sulfide gas—if present in landfill off gasses—also decreases the quality and value of methane recovered from landfills as a compostable landfill material decomposition by-product. Finally, even tiny amounts of hydrogen sulfide gas smells and can cause odor issues in the surrounding environment.

In order to inhibit and/or prevent the formation of hydrogen sulfide from C & D fines, one or more sulfur stabilizing agents are combined with the sulfur/containing C & D waste materials. By “stabilizing agent” we mean any element, compound or combinations of one or both that prevent or inhibit the formation of H₂S from sulfates or that binds to H₂S after it forms to render it inert—preferably under reducing conditions. Examples of useful classes of sulfur stabilizing agents include metal oxide and metal hydroxide materials where examples of several useful metals forming these compounds are iron and calcium.

One class of useful sulfur stabilizing agents is iron compounds including ferric and ferrous hydroxide and zero valence iron. Another class of useful sulfur stabilizing agents is calcium compounds such as calcium hydroxide, calcium carbonate, calcium oxide and so forth. Yet another example of a useful sulfur stabilizing agent is naturally occurring calcium hydroxide which is referred to herein as lime and more preferably hydrated lime. Other useful sulfur stabilizing agents include Portland cement and fly ash. The sulfur stabilizing agent may be a single compound or it may be a combination of two or more of the sulfur stabilizing agents mentioned above such as, for example ferric oxide and lime.

The sulfur stabilizing agent(s) should be combined with the sulfur containing construction and demolition waste in an amount sufficient to at least inhibit the generation of hydrogen sulfide gas from the sulfur containing waste materials at reducing conditions. By “inhibit” we mean reduce the emission of H₂S by at least 50% in comparison to H₂S generated from C&D fines without sulfur stabilizing agent at landfill conditions. More preferably, the sulfur stabilizing agent will be added in an amount sufficient to inhibit the formation of H₂S by at least 90% in comparison to H₂S generated from C&D fines without sulfur stabilizing agents at landfill conditions. Most preferably, enough sulfur stabilizing agent will be added to the C&D fines to prevent the formation of H₂S gas for at least one year and more preferably at least five years and more preferably for twenty or more years.

A useful amount of sulfur stabilizing agent will vary depending upon parameters such as the choice of stabilizing agent, the amount of sulfur in the construction and demolition waste material and the environmental conditions—e.g., average annual rainfall. Generally, an amount of sulfur stabilizing agent(s) ranging from about 5 lbs. of sulfur stabilizing agent per ton of waste material to 100 lbs. of sulfur stabilizing agent per ton of waste material will be sufficient. When lime is a sulfur stabilizing agent, an amount of sulfur stabilizing agent(s) ranging from about 15 lbs. of sulfur stabilizing agent per ton of waste material to about 50 lbs. of sulfur stabilizing agent per ton of sulfur containing C & D waste material and preferably 20 lbs. to 45 lbs. of sulfur stabilizing agent per ton of sulfur containing C & D waste will be sufficient for almost all applications.

In some cases when adding iron stabilizing agents to the C & D fines, the added sulfur stabilizing agents convert hydrogen sulfide gas produced under the anaerobic (reducing) conditions into pyrite (an inert FeS₂ or Fe₂S₃). In one alternative, adding hydrated lime to the sulfur containing construction and demolition waste mixture has the added benefit of maintaining the combined sulfur stabilized C&D material pH above 9.5 and as high as 12.0. By keeping the pH higher than about 9.5, the amount of hydrogen sulfide that is produced is further reduced.

In addition to preventing the formation of hydrogen sulfide gas under anaerobic conditions, the combined materials can be used in landfills under extended life treatment. In one embodiment, a sufficient amount of sulfur stabilizing agent can be added to the sulfur containing construction and demolition materials to inhibit hydrogen sulfide gas production for up to 100 years by loading the construction and demolitions fines with a sulfur stabilizing agent such as calcium hydroxide in excess of the amounts necessary to raise the pH of the C & D fines to 9.5 or above.

In addition to iron oxide, iron hydroxide or calcium oxide or hydroxide, Portland cement or in some cases fly ash can be used as sulfur stabilizing agents. Fly ash can be added to sulfur containing C & D fines when the admixed material is being placed in an inert landfill, like an ash monofill. In addition, pH driving additives that do not stabilize sulfur in the C & D fines but that help increase and/or maintain the pH of the admixture at a pH of 9.5 or greater can be used.

The sulfur containing construction and demolition waste may be admixed with the sulfur stabilizing agent using a variety of methods. The methods may be batch methods or continuous methods. The selection of admixing method will depend largely upon the volume of sulfur containing construction and demolition waste being treated as well as the capabilities of the facility at which the sulfur and demolition waste is being disposed. As a first step, the sulfur containing construction and demolition waste material may need to be crushed or reduced in size. The construction demolition waste is reduced in size to “fines” having an average particle size range of from about 0.1 mm inches to about 4.0 inches or greater. More preferably, the fines size ranges from about 0.1 mm to about 2 inches. In general 80 weight percent and more preferably 95 weight percent of the sulfur containing C & D fines will fall within these size ranges.

Larger pieces of sulfur containing C & D materials can be treated in the methods of this invention. When large pieces are present, then they are generally less than four inches across. Note, in some cases the non-recyclable residuals (which can be much larger than 4″) are also treated if they contain sulfates. “Residuals” are defined herein as presently non-recyclable materials that are typically landfilled.

The C & D materials that are directed to a landfill are often very large in size and would not be easily treated by the methods of this invention. In this case, size reduction equipment can be used on a continuous or batch-wise basis to reduce the size of large pieces of sulfur containing C & D materials into sulfur containing C & D fines. If a continuous size reduction process is used, then one or more sulfur stabilizing agents may be applied to the construction and demolition fines on a continuous basis such as, for example, by applying one or more sulfur stabilizing agents to the C & D fines as the fines move down a conveyor belt following size reduction and/or size classification. Alternatively, one or more sulfur stabilizing agent can be applied to the sulfur containing C & D fines on a batch-wise basis. For example, one or more sulfur stabilizing agents can be added batch-wise to C & D fines located in pits, on the open ground, in large mixing vessels and the like after. Next, the combination of materials is admixed using manual or mechanical techniques such as mixers, paddles, shovels, and even by using heavy machinery such as front end loaders.

Some examples of useful solids mixers include paddle mixers or rotary mixers. These mixers provide advantages in comparison to more manual techniques because without adequate retention time during mixing, the sulfur compounds do not come in contact with the pH adjusting chemistry. This can result in bacteria transforming these untreated particles to hydrogen sulfide.

The sulfur stabilizing agent may be added to the sulfur containing construction and demolition waste material in any form that is useful in the admixing process to coat and stabilize the C&D fines sulfur. The sulfur stabilizing agent may be added as a solid material such as a powdered or granular solid. Alternatively, the one or more sulfur stabilizing agents can be added as an aqueous solution or slurry. In one method, aqueous lime slurry is sprayed onto construction and demolition fines as they pass down a conveyer belt or are otherwise conveyed from a size reduction process.

In yet another method, sulfur containing C & D fines are placed in a layer in municipal solid waste landfill as, for example, daily cover and thereafter a sulfur stabilizing agent is applied to the daily cover material to form a sulfur stabilized daily cover material. The following day, municipal solid waste is added to the top surface of the sulfur stabilizing daily fill material and then these steps are repeated.

The sulfur stabilized construction and demolition materials of this invention have a variety of beneficial uses. In one use, the sulfur stabilized construction and demolition waste materials are applied as a daily cover to municipal solid waste landfill. If the sulfur stabilized construction and demolition material is used as a daily cover, then it is preferred that the daily cover will have a thickness of from about 6 inches to about 10 feet or more and preferably from about 1 foot to about 4 feet in depth.

In another use, the sulfur stabilized construction and demolition waste materials are used as a substitute for sand or aggregate as base material for roadways in and around municipal solid waste landfills and other types of landfills.

### EXAMPLES

Two sets of experiments have been conducted to evaluate the potential release of sulfate from C&D fines. In one set of experiments, referred to as column tests, mixtures of C&D fines and lime were packed into columns. Water was passed through the columns under a constant head and the release of sulfate was measured. In a second set of experiments, referred to as batch leaching tests, sulfate release was measured from mixtures of C&D fines and lime to which simulated leachate was added.

### Example 1

### Column Tests

C&D fines received from the Orchard Ridge Landfill were screened to remove material greater than about 0.25″ and dried at 105° C. The release of sulfate was measured for each of three treatments; no lime, 10 lb. of lime per ton of C&D fines, and 40 lb. of lime per ton of C&D fines.

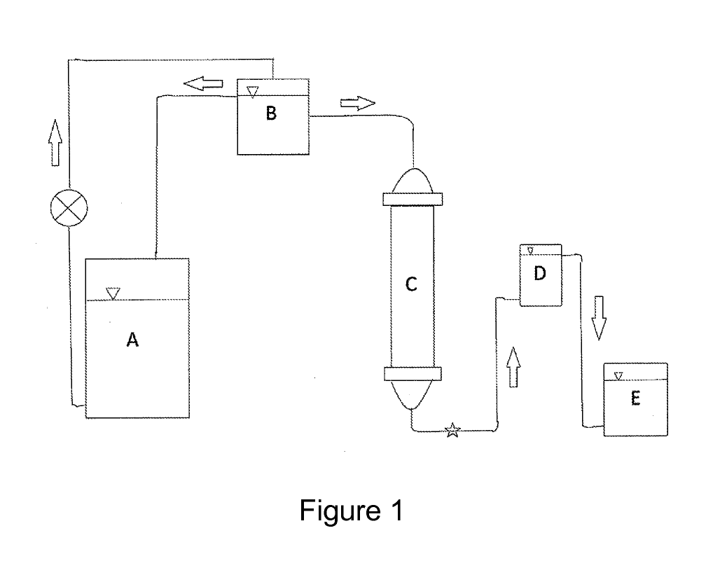

Each treatment was tested in triplicate. C&D fines and lime were added to a 6 inch diameter column having a length of 40 inches at an approximate density of 1,600 lb. per yd³. A scotch brite pad was placed on the bottom of the column to serve as a barrier to large particles. The C&D fines were filled to the top of the column by adding 3″ layers. Each layer was compacted 40 times with a −2″ plastic mallet and 20 times with a −0.5″ metal rod. The column was closed with a top cap and the top cap of the column was filled with deionized (DI) water. A schematic of the column is shown in FIG. 1.

A constant head of DI water was supplied to the columns by gravity feed from the top container. A constant water level was maintained in the top container by a pumping water into the top of the container (B in FIG. 1) and allowing excess water to drain back to the supply container (A in FIG. 1) from a port in the side of the container. Backpressure was also supplied to the column by maintaining an outlet container (D in FIG. 1) connected to the bottom of the column. A constant water level was maintained in the outlet container by a port that allowed water to drain to the waste container (E in FIG. 1). The flow rate in the column was adjusted by raising or lowering the level of the outlet container.

Water was allowed to flow through the columns for approximately 30 days and the water flow rate was measured by the volume collected in the waste container. In order to determine the concentration of sulfate released from the column, samples were collected from a sample port—identified by the star in FIG. 1—between the column (C) and the outlet container (D). The concentration of sulfate in each sample was measured by ion chromatography.

Results

The sulfate released from the columns was tracked over time. Initially, there was a surprisingly high release of sulfate in the treatments with no lime and 10 lb. lime/ton, but not an initially high release rate in the 40 lb. lime/ton column. In all treatments, after several days, the steady state sulfate release dropped to between 1300 and 1400 mg/L.

The mass of sulfate released from the column C & D fines was calculated from the measured sulfate concentrations and water flow rate to determine cumulative sulfate release as a fraction of the added sulfate. The data demonstrated that sulfate release is rapid so that any operational strategy that minimizes the exposed surface area and infiltration will be beneficial. Practically, this suggests that thicker layers of fines will result in less sulfate release than fewer thinner layers of fines. In addition, the data indicated that the 40 lb. lime/ton dose lowered the amount of sulfate leaching from the columns relative to no lime and the 10 lb. lime/ton dose.

At the completion of each column test, the columns were destructively sampled for measurement of residual sulfate. Four 15 gsamples of the material from each column were dissolved for five days in 2 L of DI water adjusted to pH 1 with HCl. Previous experiments demonstrated that a pH 1 solution dissolves the maximum amount of sulfate in the sample in five days. Sulfate recovery accounted for between 90% and 107% of the added sulfate.

### Example 2

### Batch Leaching Tests

The objective of the batch leaching tests was to measure the solubility of sulfate in C&D fines at different pH levels, as the pH of landfill leachate will vary during waste decomposition. Sulfate solubility was measured in a pH 7 phosphate buffer; in synthetic methane phase leachate (pH 6.5-7.5), and in acid phase leachate (pH 4.5-5.5). To evaluate the effect of lime on sulfate solubility, we measured sulfate release in the C&D fines and in C&D fines plus 20 and 80 lb./ton of lime, respectively.

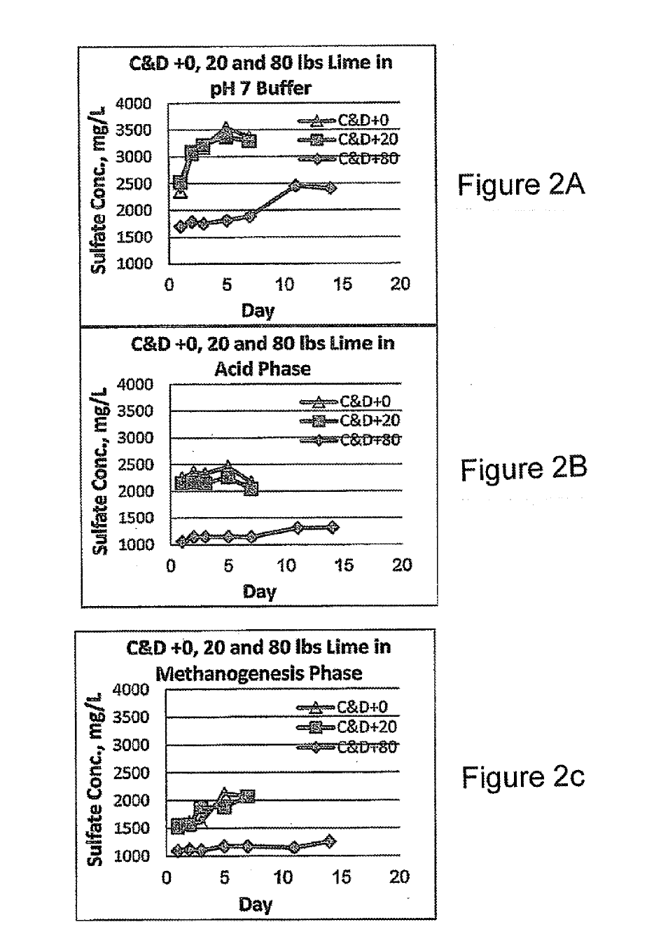

The results of the leaching tests are summarized in the plots at FIGS. 2A-2C. The plots illustrate that the pH of landfill leachate did not affect sulfate solubility, as the sulfate concentrations in the acid phase leachate were not significantly different from that in the methane phase leachate. The addition of lime at the highest ratio (80 lbs. per ton) significantly reduced the solubility of sulfate. Surprisingly, sulfate solubility increased in the presence of the phosphate buffer that included potassium and sodium phosphate. Finally, the results demonstrated that the solubility of the calcium was significantly affected by the pH. The calcium solubility decreased from about 2500 mg/L in acid phase leachate to 1300 mg/L in methane phase leachate.

Discussion of Experimental Data

The laboratory scale experiments, followed by field trials, have shown that the addition of lime to the C&D fines mixture (40 lbs. lime/ton C&D fines) can raise the pH and inhibit the biological reaction by which calcium sulfate is converted to H₂S.

The field data from actual landfill applications has been matched with rainfall data where we are receiving fines and the lab data on leachability of sulfates. Using this data we constructed a simple model which shows the addition of lime to C & D fines could provide protection from H₂₅ for as long as 100 years. The results of the lab work show that 40 pounds per ton of lime reduces the sulfate release relative to 0 and 20 pounds/ton additions. As an example, a landfill that produced 6000 cfm of gas would have a predicted hydrogen sulfide concentration of 265 ppm assuming three 1 foot thick layers of C&D fines over the depth of the landfill and 50 acres of “alternative daily cover” (ADC).

The following are some of the conclusions reached after considering the experimental data:
A smaller number of thicker layers of ADC containing sulfur stabilized C&D fines are preferable to a larger number of thinner layers because sulfate release to the waste is controlled by area.
The time sulfur stabilized ADC can remain in-place as cover is directly related to precipitation.
Sulfur stabilized C&D fines are best applied as ADC on dry days. Stockpiles should be covered to avoid wet weather.

### Example 3

### Drum Tests

Sulfur containing construction and demolition fines were prepared. Batches of the C & D fines were combined with different sulfur stabilizing agents such as lime and Fe(OH₃) in varying amounts and the mixtures were placed in a 55 gallon drums. Some of the drums were dosed with cow manure or leachate. The contents of all of the drums were covered with compost. The contents of the drums were allowed to ferment. Gas samples were taken from the drums about every two weeks and analyzed for H₂S. The testing was performed in triplicate and one set of drums was a control drum.

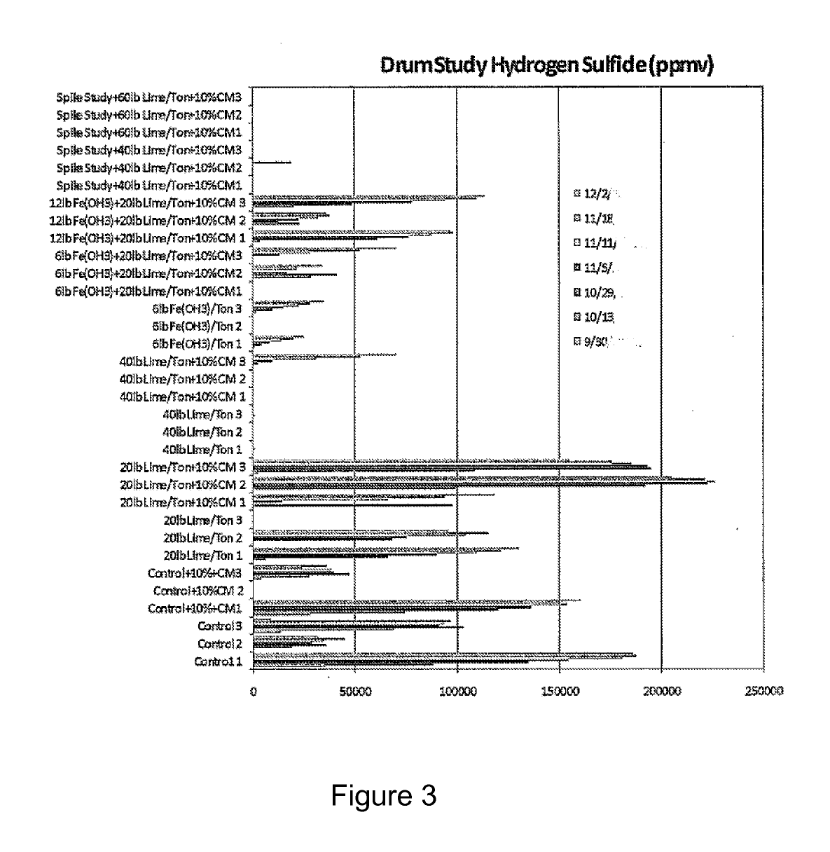

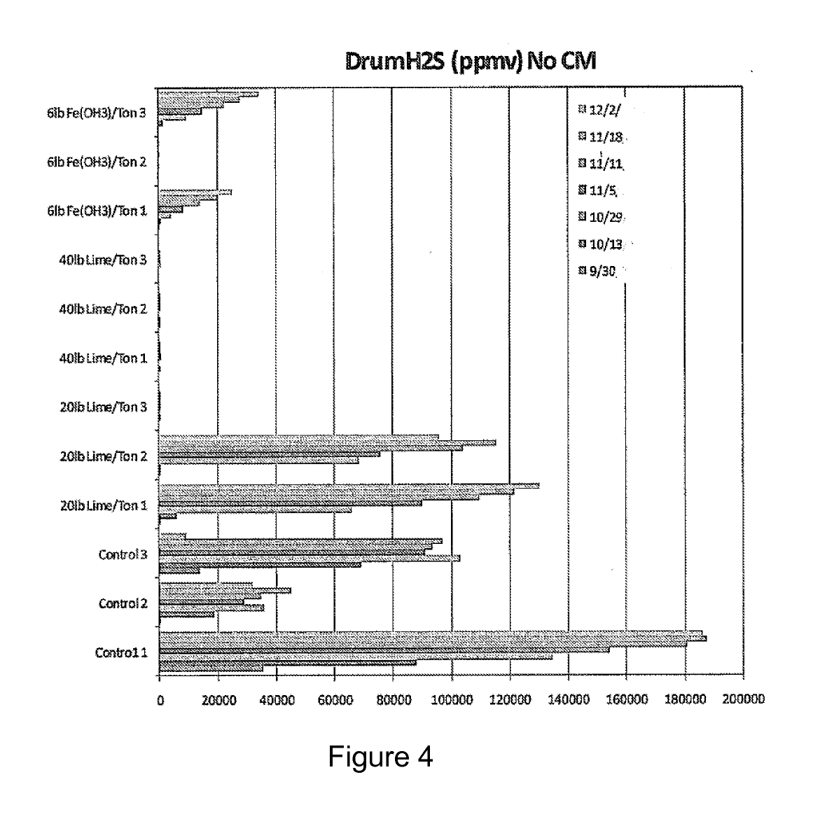

FIG. 3 is a plot of the H₂₅ in the headspace of each of the drums over time. FIG. 4 is a plot of the same data but excluding drums dosed with cow manure. The results show that both line and Fe(OH₃I are effective sulfur stabilizing agents when added to sulfur containing C & D fines in appropriate amounts. In particular, with the drums not inoculated with cow manure, Fe(OH₃) admixed with C & D fines at a ratio of 6 lbs./ton was able to reduce H₂₅ production by over 50% in comparison to the control. When lime was used as the sulfur stabilizing agent, 20 lbs./ton almost entirely inhibited H₂₅ production in some drums while adding the lime at a ratio of 40 lbs./ton was successful in all three tests in almost entirely inhibiting H₂s production.

What is claimed is:

1. A method of remediating construction and demolition waste comprising the steps of:
Collecting sulfur containing construction and demolition waste materials;
adding a sulfur stabilizing agent to the construction and waste materials; and
admixing the sulfur containing construction and demolition waste materials and the sulfur stabilizing agent to form sulfur stabilized construction and demolition waste material.

2. The method of claim 1 wherein the construction and waste materials include from greater that 0 to about 15 wt % of sulfur containing waste materials.

3. The method of claim 1 wherein the sulfur stabilizing agent is a metal oxide, a metal hydroxide or a mixture thereof.

4. The method of claim 4 wherein the metal of the sulfur stabilizing agent is iron, calcium or mixtures thereof.

5. The method of claim 1 wherein the sulfur stabilizing agent is lime.

6. The method of claim 5 wherein the sulfur stabilizing agent includes lime and a second sulfur stabilizing agent.

7. The method of claim 6 wherein the second sulfur stabilizing agent is a metal hydroxide, a metal oxide, or a mixture thereof where the metal is not calcium.

8. The method of claim 6 wherein the second sulfur stabilizing agent is iron hydroxide, iron oxide, or a mixture thereof.

9. The method of claim 1 wherein the sulfur stabilizing agent is added to the sulfur containing demolition waste material in an amount ranging from about 5 to about 100 lb./ton.

10. The method of claim 1 wherein the sulfur stabilizing agent is added to the sulfur containing demolition waste material in an amount ranging from about 15 to about 50 lb./ton.

11. The method of claim 1 wherein the sulfur containing construction and demolition waste is in the form of fines.

12. The method of claim 11 wherein the fines have an average particle size o from about 0.1 mm to about 2 inches.

13. The method of claim 11 wherein the sulfur containing construction and demolition waste fines and the sulfur stabilizing agent are admixed in a batch process.

14. The method of claim 1 wherein the sulfur stabilized construction and demolition waste material is applied as daily cover to a landfill.

15. The method of claim 14 wherein the daily cover is applied to a depth of from about 1 foot to about 4 feet.

16. The method of claim 1 wherein the sulfur stabilized construction and demolition waste material is used as road base material.

17. The method of claim 1 wherein the pH of the sulfur stabilized construction and demolition waste material is 9.5 or greater.

18. A method of remediating construction and demolition waste comprising the steps of:
collecting sulfur containing construction and demolition waste materials;
reducing the particle size of the sulfur containing construction and demolition waste materials to an average particle size of from about 0.1 mm to about 2 inches;
adding hydrated lime to the size reduced construction and waste materials;
admixing the size reduced sulfur containing construction and demolition waste materials and the hydrated lime in an amount ranging from about 25 lbs. per ton to about 45 lbs. per ton to form a sulfur stabilized construction and demolition waste material; and
using the sulfur stabilized construction and demolition waste material in a landfill application.

19. A municipal solid waste landfill comprising:
a plurality of municipal solid waste layers; and
a layer of daily cover material separating at least two of the plurality of municipal solid waste layers wherein the daily cover material is an admixture of at least one sulfur stabilizing agent and sulfur containing construction and demolition fines.

20. The municipal solid waste landfill of claim 19 wherein the sulfur stabilizing agent is a metal oxide, a metal hydroxide or a mixture thereof.

21. The municipal solid waste landfill of claim 20 wherein the metal of the sulfur stabilizing agent is iron, calcium or mixtures thereof.

22. The municipal solid waste landfill on claim 19 wherein the sulfur stabilizing agent is lime.

23. The municipal solid waste landfill of claim 19 wherein the sulfur stabilizing agent is added to the sulfur containing demolition waste material in an amount ranging from about 5 to about 100 lb./ton.

24. The municipal solid waste landfill of claim 19 wherein the sulfur stabilizing agent is added to the sulfur containing demolition waste material in an amount ranging from about 25 to about 50 lb./ton.

25. The municipal solid waste landfill of claim 19 wherein sulfur containing construction and demolition waste is in the form of fines having an average particle size of from about 0.1 mm inches to about 2 inches.
